(19) United States
(12) Patent Application Publication
(10) Pub. No.: US 2021/0014008 A1
(43) Pub. Date: Jan. 14, 2021

(54) USER TERMINAL AND BASE STATION

(71) Applicant: NTT DOCOMO, INC., Tokyo (JP)

(72) Inventors: Kazuki Takeda, Tokyo (JP); Shohei Yoshioka, Tokyo (JP); Satoshi Nagata, Tokyo (JP); Lihui Wang, Beijing (CN); Xiaolin Hou, Beijing (CN)

(73) Assignee: NTT DOCOMO, INC., Tokyo (JP)

(21) Appl. No.: 17/040,646

(22) PCT Filed: Mar. 27, 2018
(86) PCT No.: PCT/JP2018/012574

§ 371 Date: Sep. 23, 2020

(51) Int. Cl. H04L 1/18; H04W 72/04; H04L 1/08; H04L 1/00

(52) U.S. Cl. CPC H04L 1/1816; H04W 72/042; H04W 72/0453; H04L 1/0001; H04L 1/08

(57) ABSTRACT

To carry out communication properly even when BWP switching and repetition transmission are used, a user terminal, according to one aspect of the present disclosure, has at least one of a receiving section and a transmission section, the receiving section receiving a downlink channel that is transmitted in repetition, and the transmission section transmitting an uplink channel in repetition, in one or more partial frequency bands (BWPs (Bandwidth Parts)) configured in a carrier, and a control section that exerts control so that, when a switch from a first BWP to a second BWP is commanded or configured during the repetition transmission, at least one of the receipt of the downlink channel and the transmission of the uplink channel is stopped or carried out based on a configuration of the first BWP or a configuration of the second BWP.

### TECHNICAL FIELD

The present invention relates to a user terminal and a base station in next-generation mobile communication systems.

### BACKGROUND ART

In the UMTS (Universal Mobile Telecommunications System) network, the specifications of long-term evolution (LTE) have been drafted for the purpose of further increasing high speed data rates, providing lower latency and so on (see non-patent literature 1). In addition, successor systems of LTE are also under study for the purpose of achieving furthermore, broadbandization and increased speed beyond LTE (referred to as, for example, “LTE-A (LTE-Advanced),” “FRA (Future Radio Access),” “4G,” “5G,” “5G+(plus),” “NR (New RAT),” “LTE Rel. 14,” “LTE Rel. 15 (or later versions),” etc.).

Furthermore, in existing LTE systems (for example, LTE Rel. 8 to 13), downlink (DL) and/or uplink (UL) communication are carried out by using subframes of 1 ms as scheduling units. For example, when normal cyclic prefix (NCP) is used, this subframe is comprised of 14 symbols with 15-kHz subcarrier spacing. This subframe is also referred to as a “transmission time interval (TTI)” and so on.

Furthermore, a user terminal (UE (User Equipment)) controls the receipt of a DL data channel (also referred to as, for example, “PDSCH (Physical Downlink Shared CHannel),” “DL shared channel,” etc.) based on downlink control information (DCI (also referred to as “DL assignment,” etc.)) from a radio base station (for example, eNB (eNodeB)). Furthermore, a user terminal controls the transmission of a UL data channel (referred to as, for example, “PUSCH (Physical Uplink Shared CHannel),” “UL shared channel,” etc.) based on DCI (also referred to as “UL grant,” etc.) from a radio base station.

### CITATION LIST

### Non-Patent Literature

Non-Patent Literature 1: 3GPP TS36.300 V8.12.0 “Evolved Universal Terrestrial Radio Access (E-UTRA) and Evolved Universal Terrestrial Radio Access Network (E-UTRAN); Overall Description; Stage 2 (Release 8),” April, 2010

### SUMMARY OF INVENTION

### Technical Problem

Envisaging future radio communication systems (hereinafter referred to as “NR”), study is underway to use one or more partial frequency bands (also referred to as “partial bands,” “bandwidth parts (BWPs),” etc.) in a carrier (also referred to as, for example, a “component carrier (CC),” a “system band,” etc.) for DL and/or UL communication (DL/UL communication).

In this way, when one or more frequency bands (for example, BWPs) for use for DL/UL communication can be configured in a carrier, the BWP to use for communication may be switched and controlled. Furthermore, for NR, applying repetition transmission to at least one of UL signals (or UL channels) and DL signals (or DL channels) are also under study.

However, not much research has been conducted yet on how to control repetition transmission when communication is carried out by switching BWPs. When applying BWP switching and repetition transmission, flexible control is not possible unless an appropriate control method is used, and this might cause a deterioration of communication throughput, communication quality, and so forth.

It is therefore an object of the present disclosure to provide a user terminal and a base station, whereby communication can be carried out properly even when BWP switching and repetition transmission are used.

### Solution to Problem

In accordance with one aspect of the present invention, a user terminal has at least one of a receiving section and a transmission section, the receiving section receiving a downlink channel that is transmitted in repetition, and the transmission section transmitting an uplink channel in repetition, in one or more partial frequency bands (BWPs (Bandwidth Parts)) configured in a carrier, and a control section that exerts control so that, when a switch from a first BWP to a second BWP is commanded or configured during the repetition transmission, at least one of the receipt of the downlink channel and the transmission of the uplink channel is stopped or carried out based on a configuration of the first BWP or a configuration of the second BWP.

### Advantageous Effects of Invention

According to the present invention, communication can be carried out properly even when BWP switching and repetition transmission are used.

### BRIEF DESCRIPTION OF DRAWINGS

FIGS. 1A to 1C are diagrams to show examples of BWP-configuring scenarios;

FIG. 2 is a diagram to show an example of BWP activation/deactivation control;

FIGS. 3A and 3B are diagrams to show examples of repetition transmission control when applying BWP switching;

FIGS. 4A and 4B are diagrams to show other examples of repetition transmission control when applying BWP switching;

FIG. 5 is a diagram to show an exemplary schematic structure of a radio communication system according to the present embodiment;

FIG. 6 is a diagram to show an exemplary overall structure of a radio base station according to the present embodiment;

FIG. 7 is a diagram to show an exemplary functional structure of a radio base station according to the present embodiment;

FIG. 8 is a diagram to show an exemplary overall structure of a user terminal according to the present embodiment;

FIG. 9 is a diagram to show an exemplary functional structure of a user terminal according to the present embodiment; and

FIG. 10 is a diagram to show an exemplary hardware structure of a radio base station and a user terminal according to the present embodiment.

### DESCRIPTION OF EMBODIMENTS

Now, envisaging a future radio communication system (for example, NR, 5G or 5G+), research is underway to allocate a carrier (also referred to as “component carriers (CCs),” “cells,” “system bands,” etc.) having a wider bandwidth (for example, 100 to 800 MHz) than in existing LTE systems (for example, LTE Rel. 8 to 13).

Meanwhile, in this future radio communication system, user terminals having capabilities for transmission and/or receipt in the entire carrier (also referred to as a “wideband (WB) UE,” a “single-carrier WB UE,” etc.) and user terminals not having capabilities for transmission and/or receipt in the entire carrier (also referred to as a “BW (BandWidth)-reduced UE,” etc.) are likely to co-exist.

In this way, in a future radio communication system, a number of user terminals (various BW UE capabilities) are likely to co-exist in a supported bandwidth, and it naturally follows that configuring one or more partial frequency bands in a carrier, semi-statically, is under study. Each frequency band (for example, 50 MHz or 200 MHz) in this carrier is referred to as a “partial band,” a “bandwidth part (BWP),” and so on.

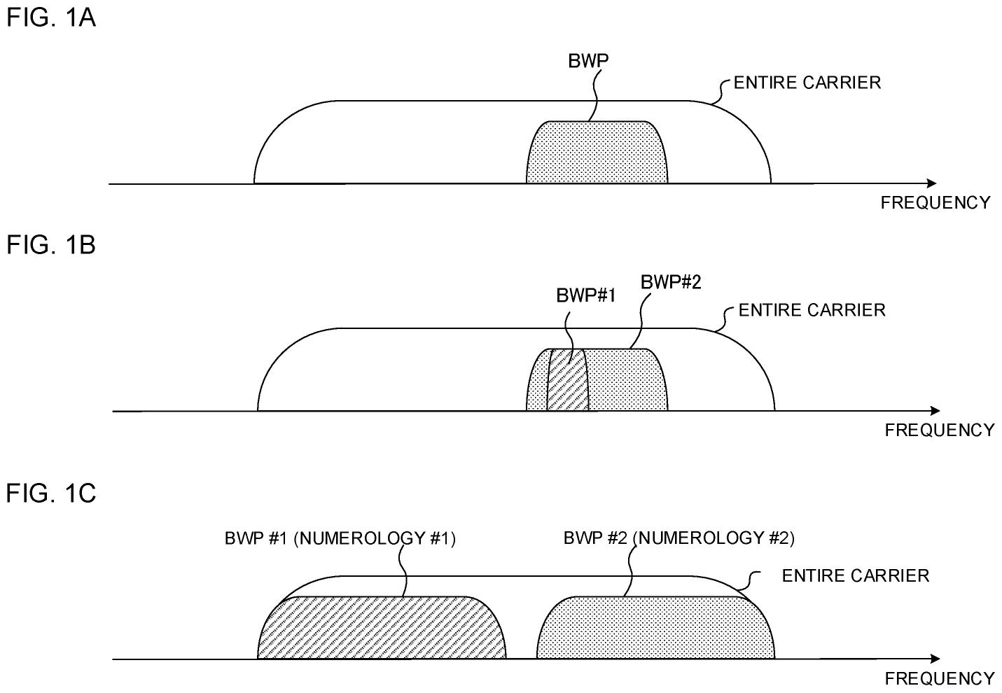

FIG. 1 are diagrams to show examples of BWP-configuring scenarios. FIG. 1A shows a scenario in which a user terminal is configured with one BWP in one carrier (usage scenario #1). For example, in FIG. 1A, a 200-MHz BWP is configured within an 800-MHz carrier. The activation or deactivation of this BWP may be controlled.

Here, activating a BWP means providing a state in which this BWP can be used (or making a transition to a state in which this BWP can be used), and may be seen as, for example, activation or enablement of the BWP's configuration information (BWP configuration information). Also, deactivating a BWP means providing a state in which this BWP cannot be used (or making a transition to a state where the BWP cannot be used), and may be seen as, for example, deactivation or disablement of the BWP's configuration information. When a BWP is scheduled, this BWP is activated.

FIG. 1B shows a scenario in which a user terminal is configured with a number of BWPs in one carrier (usage scenario #2). As shown in FIG. 1B, a number of BWPs (for example, BWPs #1 and #2) may at least partially overlap. For example, in FIG. 1B, BWP #1 is a part of the frequency band of BWP #2.

Also, the activation or deactivation of at least one of these BWPs may be controlled. For example, referring to FIG. 1B, BWP #1 may be activated when no data is transmitted and/or received, and BWP #2 may be activated when data is transmitted and/or received. To be more specific, when data to be transmitted and/or received is generated, BWP #1 may be switched to BWP #2, and, when the transmission and/or the receipt of the data is finished, BWP #2 may be switched to BWP #1. In this way, the user terminal does not need to keep monitoring BWP #2, which has a wider bandwidth than BWP #1, so that power consumption can be reduced.

Note that, referring to FIGS. 1A and 1B, the network (which is, for example, a radio base station) needs not assume that a user terminal receives and/or transmits outside the active BWP.

Note that, in FIG. 1A, a user terminal that supports the whole carrier, is not prevented, in any way, from receiving and/or transmitting signals outside of the BWP.

FIG. 1C shows a scenario in which a number of BWPs are configured in different bands within one carrier (usage scenario #3). As shown in FIG. 1C, different numerologies may be applied to these BWPs. Here, a numerology may refer to at least one of the subcarrier spacing, the length of symbols, the length of slots, the length of cyclic prefix (CP), the length of slots (transmission time intervals (TTIs)), the number of symbols per slot, and so forth.

For example, in FIG. 1C, a user terminal having capabilities for transmission and receipt in the whole carrier may be configured with BWPs #1 and #2 with different numerologies. In FIG. 1C, at least one BWP configured for the user terminal is activated or deactivated, and one or more BWPs may be active at a given time.

Note that a BWP that is used in DL communication may be referred to as a “DL BWP (DL frequency band),” and a BWP that is used in UL communication may be referred to as a “UL BWP (UL frequency band).” A DL BWP and a UL BWP may have frequency bands that at least partially overlap. Hereinafter, a DL BWP and a UL BWP will be collectively referred to as a “BWP,” unless a distinction needs to be made.

At least one of the DL BWPs configured for a user terminal (for example, a DL BWP included in the primary CC) may include a control resource field to serve as a candidate for allocating a DL control channel (DCI). This control resource field may be referred to as a “control resource set (CORESET),” a “control subband,” a “search space set,” a “search space resource set,” a “control field,” a “control subband,” an “NR-PDCCH field,” and so forth.

A user terminal monitors one or more search spaces in the control resource set, and detects the DCI for the user terminal. The search space may include a common search space (CSS), in which DCI (for example, group DCI or common DCI) that applies in common to one or more user terminals is allocated, and/or a user terminal (UE)-specific search space (USS), in which a user terminal-specific DCI (for example, DL assignment and/or UL grant) is allocated.

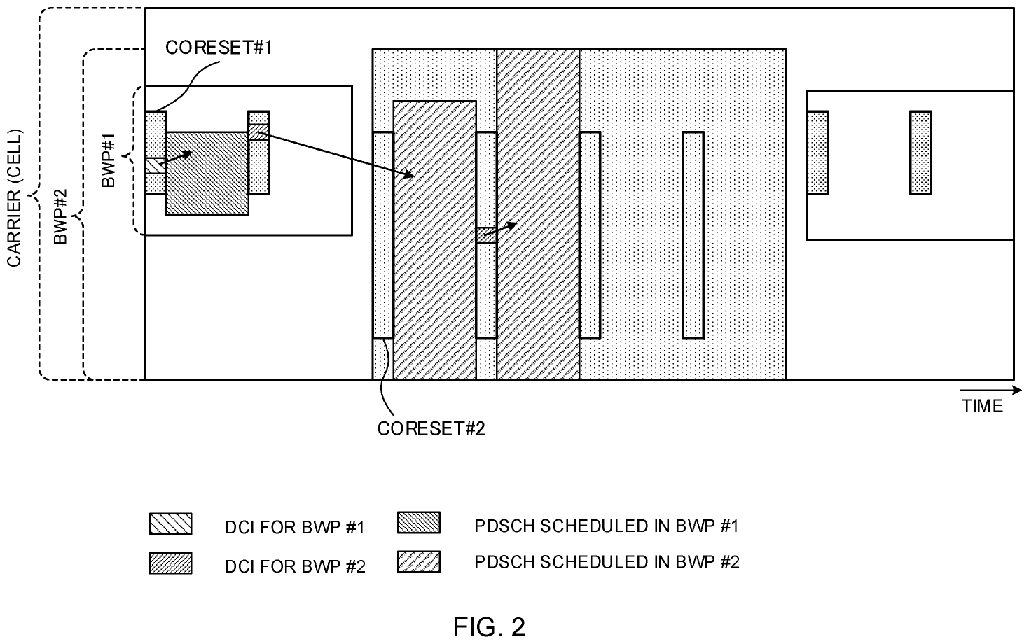

Referring to FIG. 2, how to control the activation and/or deactivation of BWPs will be described (also referred to as “activation/deactivation,” “switching,” “determination,” etc.). FIG. 2 is a diagram to show an example of control, in which one BWP is activated (a case where the BWP to activate is switched). Note that, although FIG. 2 assumes the scenario shown in FIG. 1B, this BWP activation/deactivation control can be suitably applied to the scenarios shown in FIGS. 1A and 1C and the like.

In FIG. 2, CORESET #1 is configured in BWP #1, and CORESET #2 is configured in BWP #2. One or more search spaces are provided in each of CORESETs #1 and #2. For example, in CORESET #1, the DCI for BWP #1 and the DCI for BWP #2 may be allocated in the same search space, or may be allocated in different search spaces.

Also, in FIG. 2, when BWP #1 is in the active state, the user terminal monitors (blind-decodes) the search space in CORESET #1 in a predetermined cycle (for example, for every one or more slots, every one or more minislots, or every predetermined number of symbols), and detects the DCI for the user terminal.

The DCI may include information (BWP information) that indicates which BWP the DCI corresponds to. This BWP information may be, for example, a BWP index, or may be a predetermined field value in DCI. Furthermore, the BWP index information may be included in DCI for downlink scheduling, may be included in DCI for uplink scheduling, or may be included in DCI of the common search space. The user terminal may identify the BWP where a PDSCH or a PUSCH is scheduled by the DCI, based on the BWP information in the DCI.

When the user terminal detects DCI for BWP #1 in CORESET #1, the user terminal receives the PDSCH that is scheduled (allocated) in a predetermined time and/or frequency resource (time/frequency resource) in BWP #1, based on the DCI for BWP #1.

Also, when the user terminal detects DCI for BWP #2 in CORESET #1, the user terminal deactivates BWP #1 and activates BWP #2. The user terminal receives the PDSCH that is scheduled in a predetermined time/frequency resource in DL BWP #2, based on the DCI for BWP #2, detected in CORESET #1.

Note that, although, in FIG. 2, the DCI for BWP #1 and the DCI for BWP #2 are detected at different timings in CORESET #1, it is also possible to detect a number of DCIs for different BWPs at the same timing. For example, a number of search spaces that respectively correspond to a number of BWPs may be provided in CORESET #1, and a number of DCIs for different BWPs may be transmitted in these search spaces, respectively. The user terminal may monitor a number of search spaces in CORESET #1, and detect a number of DCIs for different BWPs at the same timing.

When BWP #2 is activated, the user terminal monitors (blind-decodes) the search space in CORESET #2 in a predetermined cycle (for example, for every one or more slots, every one or more minislots, or every predetermined number of symbols), and detects the DCI for BWP #2. The user terminal may receive the PDSCH that is scheduled in a predetermined time/frequency resource in BWP #2, based on the DCI for BWP #2 detected in CORESET #2.

Note that, although FIG. 2 shows a case where a predetermined time is provided to switch between activation and deactivation, but this predetermined time may not be required.

As shown in FIG. 2, in the event activation of BWP #2 is triggered by the detection of DCI for BWP #2 in CORESET #1, it is possible to activate BWP #2 without explicit command information, so that it is possible to prevent an increase in overhead due to the control of activation.

Also, when no data channel (for example, PDSCH and/or PUSCH) is scheduled for a predetermined period in an activated BWP, this BWP may be deactivated. For example, in FIG. 2, no PDSCH is scheduled for a predetermined period in DL BWP #2, and therefore the user terminal deactivates BWP #2 and activates BWP #1.

Furthermore, apart from sending notifications from base stations to UEs, BWP switching may be controlled using a timer. For example, a configuration may be employed, in which a timer is started when a BWP is switched, and the BWP is switched to a predetermined BWP when the timer expires. BWP switching using DCI and BWP switching using a timer may be applied at the same time.

Now, NR is under study to apply repetition transmission (also referred to as simply “repetition”) to at least one of DL transmission and UL transmission. For example, a base station repeats transmitting DL data (for example, a downlink shared channel (PDSCH)) a predetermined number of times. Alternatively, a UE repeats transmitting UL data (for example, an uplink shared channel (PUSCH)) a predetermined number of times.

Also, repetition transmission may be applied to slot-based scheduling and/or to minislot-based scheduling. When repetition transmission is carried out based on slot-based scheduling over a number of slots, this repetition transmission may be referred to as “slot aggregation.”

A slot is one basic transmission unit, and is comprised of a predetermined number of symbols. For example, in the event normal CP is used, a slot period is comprised of a first number of symbols (for example, 14 symbols), and, in the event extended CP is used, a slot period is comprised of a second number of symbols (for example, 12 symbols). A minislot corresponds to a period comprised of a number of symbols equal to or less than a predetermined value (for example, 14 symbols (or 12 symbols)). For example, in DL transmission (for example, PDSCH transmission), a minislot may be comprised of a predetermined number of symbols (the number of symbols being, for example, 2, 4 or 7).

A configuration in which different resource allocation methods are applied to slot-based scheduling (also referred to as “mapping type A”) and minislot-based scheduling (also referred to as “mapping type B”) may be used.

For example, minislot-based scheduling may be comprised of two, four, or seven symbols and may be at least one of PDSCH transmission and PUSCH transmission, in which the starting symbol location can be configured flexibly. Meanwhile, a PDSCH that is subject to slot-based scheduling may be a PDSCH, in which the starting symbol location is from the zeroth to third symbol in a slot, and in which the length of symbols is equal to or greater than a predetermined value. Also, a PUSCH that is subject to slot-based scheduling may be a PUSCH, in which the starting symbol location is the zeroth symbol in a slot, and in which the length of symbols is equal to or greater than a predetermined value.

In this way, in NR, data and the like may be transmitted using slot-based scheduling and minislot-based scheduling. Meanwhile, as mentioned earlier, in the event the BWP to use for communication is switched and controlled, the problem lies in how to control repetition transmission when the BWP is switched. When applying BWP switching and repetition transmission, flexible control is not possible unless an appropriate control method is used, and this might cause a deterioration of communication throughput, communication quality, and so forth.

So, the present inventors have focused on a case where a BWP might be switched during repetition transmission, worked on controlling at least one of repetition transmission and BWP switching in this case, and arrived at the present invention.

Now, embodiments of the present invention will be described below in detail with reference to the accompanying drawings. Note that a “BWP” as used in the following description may refer to to either a “DL BWP” or a “UL BWP.” Also, in the following description, repetition transmission can be applied to the transmission of at least one of DL channels (for example, PDSCH) and UL channels (for example, at least one of PUSCH and PUCCH). “Repetition transmission,” if mentioned simply, may be applied to either DL channels or UL channels.

Also, the herein-contained embodiments may be applied to other DL signals or UL signals. Therefore, a DL channel may be interpreted as meaning a DL signal or DL transmission, and a UL channel may be interpreted as meaning a UL signal or UL transmission.

### First Example

A configuration will be described with a first example of the present invention, in which a UE does not switch the BWP (or UE is not requested to switch the BWP) while repetition transmission is in progress.

A base station may control BWP switching so that a BWP is not switched (hereinafter also referred to as “BWP switching”) during a predetermined repetition of transmission. For example, when the base station transmits a PDSCH in repetition, the base station exerts control so that, while the repetition transmission of the PDSCH is in progress, at least the DL BWP is not switched. For example, the base station does not transmit DCI for commanding DL BWP switching while the PDSCH is transmitted in repetition.

Furthermore, when the UE transmits a UL channel in repetition (for example, at least one of a PUSCH and a PUCCH), the base station exerts control so that, during the repetition transmission of the UL channel, at least the UL BWP is not switched. For example, when the base station commands repetition transmission of a PUSCH, the base station does not transmit DCI to command UL BWP switching while the repetition transmission of the PUSCH is likely to be in progress. In this way, even when BWP switching is supported, the UE can control repetition transmission just as in the case where BWP switching is not supported. As a result of this, it is possible to avoid making the control of repetition transmission complex.

Note that BWP switching is controlled assuming at least in one of the case in which command is given to UE by way of downlink control information (for example, DCI), the case in which RRC-reconfiguration is applied to the active BWP configuration, and the case in which timer control (for example, switching upon timer expiration) is used. Therefore, when repetition transmission is in progress, the base station controls the commanding of BWP switching by means of DCI, the RRC-reconfiguration of the active BWP configuration, and the timer control, so that BWP switching does not take place.

<UE Operation 1>

UE may control at least one of the receipt of a DL channel that is subject to repetition transmission and the transmission of a UL channel that is subject to repetition transmission, on the assumption that BWP switching does not take place during the period repetition transmission is in progress. By this means, even when BWP switching is supported, the UE can control repetition transmission just as in the case where BWP switching is not supported. As a result of this, it is possible to avoid making the control of repetition transmission complex.

<UE Operation 2>

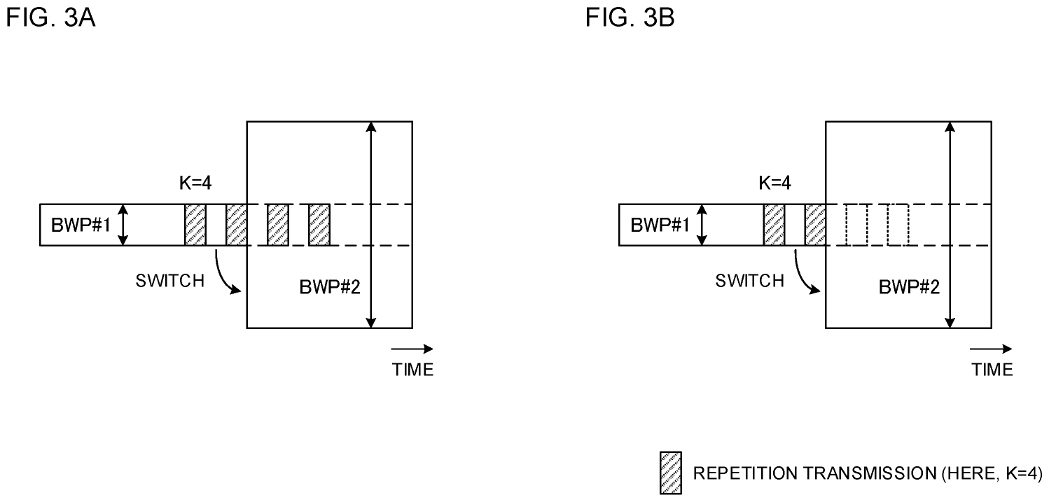

If BWP switching is reported or configured while repetition transmission is in progress, the UE may continue the operation of repetition transmission by using the BWP configuration as of before the switching (see FIG. 3A). FIG. 3A shows a case where, when UE is commanded or configured to switch from BWP #1 to BWP #2 while a predetermined number K (here, K=4) of repetition transmissions are in progress, the repetition transmission is continued. Note that the number of repetitions K=4 includes four transmissions (repetition number k=1 to 4).

For example, if the UE is commanded or configured to switch to BWP #2 while a DL channel's repetition transmission is in progress in BWP #1, the UE continues receiving the DL channel that is transmitted in repetition, by using the configuration of BWP #1. Also, when the UE is commanded or configured to switch to BWP #2 while a UL channel's repetition transmission is in progress in BWP #1, the UE continues the repetition transmission of the UL channel by using the configuration of BWP #1.

In this way, regardless of the timing BWP switching is commanded or configured, repetition transmission can be continued using the same BWP configuration. As a result of this, even when BWP switching is applied, the UE can continue repetition transmission using the same parameters (the transmission band, the number of repetitions, etc.). By this means, the decline in the quality of communication can be reduced.

<UE Operation 3>

If BWP switching is reported or configured while repetition transmission is in progress, the UE may stop or drop the operation of repetition transmission (see FIG. 3B). FIG. 3B shows a case in which, when the UE is commanded or configured to switch from BWP #1 to BWP #2 while a predetermined number K (here, K=4) of repetition transmissions are in progress, the repetition transmission is stopped or dropped before reaching the predetermined number of K.

For example, if the UE is commanded or configured to switch to BWP #2 while a DL channel's repetition transmission is in progress in BWP #1, the UE stops receiving the repeated transmissions of the the DL channel. Also, when the UE is commanded or configured to switch to BWP #2 while a UL channel's repetition transmission is in progress in BWP #1, the UE stops or drops the repeated transmissions of the UL channel.

In this case, after the UE stops or drops the repetition transmission operation in BWP #1, the UE may start communicating using BWP #2 for, for example, new transmission and/or receipt. By this means, just as when the band of BWP #1, where repetition transmission was taking place, is not included in BWP #2, transmission and reception in the non-configured band can be reduced.

Note that the UE may switch among, and control, UE operation 1, UE operation 2 (see FIG. 3A) and UE operation 3 (see FIG. 3B). For example, the base station may configure with the UE, in advance, as to which of UE operation 2 and UE operation 3 is to be employed, by using at least one of higher layer signaling and downlink control information. This allows the UE to switch between multiple UE operations.

### Second Example

With a second example of the present invention, transmission control for a retransmission control signal (also referred to as “HARQ-ACK,” “ACK/NACK,” or “A/N”) that is for use when BWP switching is commanded or configured while repetition transmission is in progress will be described. In the following description, HARQ-ACKs in response to repetition transmission of a DL channel (for example, a PDSCH) will be described by way of example, but this is by no means limiting. HARQ-ACKs in response to a UL channel that is transmitted in repetition (for example, a PUSCH) may be applied likewise.

If BWP switching is commanded or configured while repetition transmission of a PDSCH is in progress, the UE controls the transmission of HARQ-ACKs in response to the PDSCH that is transmitted in repetition. Hereinafter, the transmission control of HARQ-ACKs will be described in detail.

<HARQ-ACK Transmission Control 1>

First, a configuration will be assumed below in which, when BWP switching is reported or configured while repetition transmission is in progress, the UE continues the operation of repetition transmission using the BWP configuration as of before the switching (see FIG. 3A).

In this case, given a PDSCH that is transmitted in repetition, the UE may exert control so that (or assume that) no HARQ-ACK is transmitted in response to each transmission of the PDSCH, where BWP switching takes place while the transmission is repeated. For example, in FIG. 3A, the UE exerts control so that no HARQ-ACK is transmitted in response to the repeated transmissions of the PDSCH (repetition number k=1, 2, 3 and 4 of the PDSCH, where K=4). That is, the HARQ-ACK transmission operation is changed based on the timing of BWP switching.

Instead of generating individual HARQ-ACKs in response to each repeated transmission of the PDSCH, a one-bit HARQ-ACK may be generated in response to the transport blocks or codewords in which the PDSCH is transmitted in repetition. Alternatively, feedback of HARQ-ACKs in response to each repeated transmission of the PDSCH may be sent together at the same timing, or every HARQ-ACK may be sent, or part of the HARQ-ACKs may be bundled and sent together.

Alternatively, the UE may exert control so that, among the HARQ-ACKs in response to each repeated transmission of the PDSCH, the HARQ-ACKs, for which the timing of transmission is configured after BWP switching, are not transmitted. In this case, among the repeated transmissions of the PDSCH, the PDSCHs, for which the timing of HARQ-ACK transmission is configured before the switch to BWP #2 (for example, the repetitions of the PDSCH, where the last repetition is configured before the switch to BWP #2, or HARQ-ACKs in response to part of the repetitions of the PDSCH) may be transmitted using BWP #1.

If the HARQ-ACK codebook configuration is set on a semi-static basis (semi-static HARQ-ACK codebook configuration), HARQ-ACKs in response to the PDSCH transmissions in the DL BWP (BWP #1) before BWP switching in at least one of DL and UL are controlled not to be transmitted from the UE after the BWP switching. Note that the HARQ-ACK codebook configuration may be interpreted as meaning HARQ-ACK codebook size. When an HARQ-ACK codebook configuration is configured semi-statically, this corresponds to the case in which the base station reports an HARQ-ACK codebook size to the UE by using higher layer signaling (for example, RRC signaling).

Here, the repetition transmission of the PDSCH is assumed to refer to the PDSCHs transmitted before the BWP is switched, and a configuration is employed here in which HARQ-ACKs in response to the PDSCH transmissions, where the repetition transmissions start before BWP is switched, are not transmitted after the BWP switching. This eliminates, after the BWP switching, the need to configure resources for HARQ-ACKs in response to the PDSCH transmissions before the BWP switching, so that the HARQ-ACK operation can be made simple.

When the HARQ-ACK codebook configuration is configured on a dynamic basis (dynamic HARQ-ACK codebook configuration), HARQ-ACKs in response to the PDSCH transmissions in the DL BWP (BWP #1) before BWP switching may be controlled not to be transmitted from the UE after the BWP switching.

Here, the repetition transmission of the PDSCH is assumed to refer to the PDSCHs transmitted before the BWP is switched, and a configuration may be employed here in which HARQ-ACKs in response to the PDSCH transmissions, where the repetition transmissions start before BWP is switched, are not transmitted after the BWP switching.

The base station may control the values of DAIs to include in downlink control information based on the assumption that the UE does not generate HARQ-ACK bits in response to each PDSCH transmission where BWP switching takes place while repetition transmission is in progress. For the DAIs, at least one of a counter DAI, which shows the cumulative value of scheduled cells (or CCs), and a total DAI, which shows the total number of scheduled cells (or CCs) may be included.

Note that HARQ-ACK transmission control 1 may be similarly applied to the configuration in which the UE stops or drops the operation of repetition transmission when BWP switching is reported or configured while repetition transmission is in progress (see FIG. 3B).

For example, referring to FIG. 3B, the UE exerts control so that HARQ-ACKs in response to the PDSCHs that are transmitted in repetition (PDSCHs that are transmitted before BWP switching (repetition number k=1 and 2) and the PDSCHs that stop being transmitted or received after the BWP is switched (repetition number k=3 and 4)) are not transmitted.

Alternatively, the UE may exert control so that, among the HARQ-ACKs in response to the PDSCHs that are transmitted in repetition, the HARQ-ACKs, for which the timing of transmission is configured after the BWP switching, are not transmitted. In this case, among the repeated transmission of the PDSCH, the HARQ-ACKs, for which the timing of transmission is configured before the switch to BWP #2, may be transmitted using BWP #1.

The HARQ-ACK transmission operations for the case where the HARQ-ACK codebook configuration is set on a semi-static basis and for the case where the HARQ-ACK codebook configuration is set on a dynamic basis may be similarly applied to FIG. 3B.

<HARQ-ACK Transmission Control 2>

First, a configuration will be assumed below in which, when BWP switching is reported or configured while repetition transmission is in progress, the UE continues the operation of repetition transmission using the BWP configuration as of before the switching (see FIG. 3A).

In this case, given a PDSCH that is transmitted in repetition, the UE may exert control so that (or assume that) HARQ-ACKs are transmitted in response to each transmission of the PDSCH, where BWP switching takes place while the transmission is repeated. For example, in FIG. 3A, the UE exerts control so that HARQ-ACKs are transmitted in response to the repeated transmissions of the PDSCH (repetition number k=1, 2, 3 and 4 of the PDSCH, where K=4). That is, regardless of the timing of BWP switching, whether or not to transmit HARQ-ACKs does not change.

In this way, even if the BWP is switched during repetition transmission, HARQ-ACKs in response to repetition transmission are transmitted, so that HARQ-ACKs can be transmitted regardless of the timing of the BWP switching. By this means, the delay of retransmission control can be reduced, and the decrease in throughput can be reduced.

If the HARQ-ACK codebook configuration is set on a semi-static basis, HARQ-ACKs in response to the PDSCH transmissions in the DL BWP (BWP #1) before BWP switching in at least one of DL and UL are controlled not to be transmitted from the UE after the BWP switching.

Here, the repetition transmission of the PDSCH is assumed to refer to the PDSCHs transmitted after the BWP is switched, and a configuration is employed here in which HARQ-ACKs in response to the PDSCH transmissions, where the repetition transmissions start before the BWP is switched, are transmitted after the BWP switching.

Similarly, when the HARQ-ACK codebook configuration is set on a dynamic basis, the repetition transmission of the PDSCH may refer to the PDSCHs transmitted after the BWP is switched. That is, a configuration may be employed here in which HARQ-ACKs in response to the PDSCH transmissions, where the repetition transmissions started before the BWP is switched, are transmitted after the BWP is switched.

The base station may control the values of DAIs to include in downlink control information based on the assumption that the UE generates HARQ-ACK bits in response to each PDSCH transmission where BWP switching takes place while repetition transmission is in progress. For the DAIs, at least one of a counter DAI, which shows the cumulative value of scheduled cells (or CCs), and a total DAI, which shows the total number of scheduled cells (or CCs) may be included.

Note that HARQ-ACK transmission control 2 may be similarly applied to the configuration in which the UE stops or drops the operation of repetition transmission when BWP switching is reported or configured while repetition transmission is in progress (see FIG. 3B).

For example, in FIG. 3B, the UE exerts control so that HARQ-ACKs in response to the all the PDSCHs that are transmitted in repetition (PDSCHs that are transmitted before BWP switching (repetition number k=1 and 2) and the PDSCHs that stop being transmitted or received after the BWP is switched (repetition number k=3 and 4)) are transmitted.

The HARQ-ACK transmission operations for the case where the HARQ-ACK codebook configuration is set on a semi-static basis and for the case where the HARQ-ACK codebook configuration is set on a dynamic basis may be similarly applied to FIG. 3B.

<HARQ-ACK Transmission Timing>

When transmitting HARQ-ACKs (for example, one bit) in response to a number of PDSCHs that are transmitted in repetition (for example, HARQ-ACK transmission control 2), the UE may exert control so that the HARQ-ACKs are transmitted at a predetermined timing (for example, in a predetermined slot).

For example, the UE may exert control so that HARQ-ACKs in response to each PDSCH transmission are transmitted at a timing that comes a predetermined period (for example, after K1 slots) after the timing of the last repetition transmission (see FIG. 3A). The timing for transmitting HARQ-ACKs in response to each PDSCH transmission is controlled based on the timing of the last repetition transmission of the PDSCH, so that the HARQ-ACK timing can be controlled by taking into account the time required for the receiving process for the last received PDSCH.

The UE may also exert control so that HARQ-ACKs in response to each PDSCH transmission are transmitted at a timing that comes a predetermined period (for example, K1 slots) after the timing the last repetition transmission (for example, k=4) is configured (see FIG. 3B).

In this way, the UE may control HARQ-ACKs in response to each of a number of PDSCHs transmitted in repetition to be transmitted together (at the same timing). Here, instead of generating HARQ-ACKs in response to a number of PDSCHs transmitted in repetition, for every repetition, one bit may be generated for the transport blocks or codewords of repeated PDSCHs. When the UE receives repeated PDSCHs, the UE can demodulate, soft-combine, and decode these, and generate HARQ-ACK bits from the result.

Alternatively, the UE may control HARQ-ACKs in response to each of a number of PDSCHs transmitted in repetition to be transmitted separately (at different timings). By this means, it is possible to configure the transmission of HARQ-ACKs flexibly, both before and after BWP switching.

<HARQ-ACK Transmission Resource>

The UE may transmit HARQ-ACKs in response to PDSCHs that are transmitted in repetition, by using an uplink control channel (for example, PUCCH).

For example, the UE transmits HARQ-ACKs in response to PDSCHs that are transmitted in repetition by using PUCCH resources that are associated with the BWP configuration (for example, BWP #2 configuration in FIG. 3) after BWP switching. By this means, HARQ-ACKs can be transmitted by using the resources after the BWP switching in an effective manner.

Alternatively, the UE may transmit HARQ-ACKs in response to PDSCHs that are transmitted in repetition, by using PUCCH resources that are associated with the BWP configuration before BWP switching (for example, the BWP #1 configuration in FIG. 3) or the original BWP configuration. The original BWP configuration may be reported from the base station to the UE in advance, or may be the BWP which the UE used upon initial access.

### Third Example

With a third example of the present invention, a configuration will be described in which the UE switches the BWP (or the UE is requested to switch the BWP) while repetition transmission is in progress.

If BWP switching is commanded or configured while repetition transmission is in progress, the UE continues or restarts the repetition transmission after the BWP switching, by using the BWP configuration as of after the BWP switching. Hereinafter, a case where repetition transmission is continued after BWP switching (UE operation 1) and a case where repetition transmission is restarted after BWP switching (UE operation 2) will be described.

<UE Operation 1>

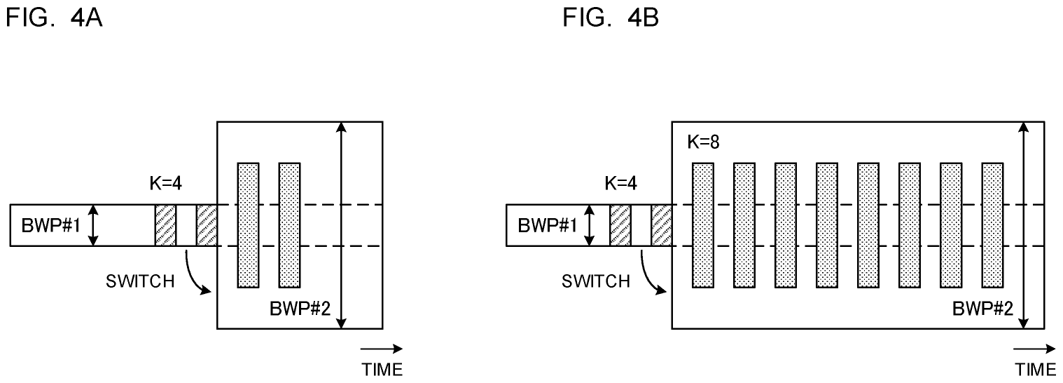

If BWP switching is reported or configured while repetition transmission is in progress, the UE continues the operation of repetition transmission by using the BWP configuration as of after the switching (see FIG. 4A). FIG. 4A shows a case where, when UE is commanded or configured to switch from BWP #1 to BWP #2 while a predetermined number K (here, K=4) of repetition transmissions are in progress, the repetition transmission is continued.

For example, if the UE is commanded or configured to switch to BWP #2 while a DL channel's repetition transmission is in progress in BWP #1, the UE continues receiving the DL channel that is transmitted in repetition, by using the configuration of BWP #2. FIG. 4A shows a case where BWP switching is made between repetition number k=2 and k=3. In this case, the UE receives the DL channel repetition transmissions corresponding to repetition numbers k=1 and 2, in BWP #1, and receives the DL channel repetition transmissions corresponding to repetition number k=3 and 4, in BWP #2.

Also, when the UE is commanded or configured to switch to BWP #2 while a UL channel's repetition transmission is in progress in BWP #1, the UE continues the repetition transmission of the UL channel by using the configuration of BWP #2. FIG. 4A shows a case where BWP switching is made between repetition number k=2 and k=3. In this case, the UE performs the UL channel repetition transmissions corresponding to repetition numbers k=1 and 2, in BWP #1, and performs the UL channel repetition transmission corresponding to repetition numbers k=3 and 4, in BWP #2.

In this way, when BWP switching takes place during repetition transmission, the repetition transmission is carried out using the BWP configured after the change, so that it is possible to control repetition transmission, flexibly, using bandwidth parts that suit the communicating environment. By this means, the decline in the quality of communication can be reduced.

<UE Operation 2>

If BWP switching is reported or configured while repetition transmission is in progress, the UE may restart the operation of repetition transmission (see FIG. 4B). FIG. 4B shows a case in which repetition transmission is restarted by changing the conditions (or parameters) for transmission when the UE is commanded or configured to switch from BWP #1 to BWP #2 while a predetermined number of K (here, K=4) of repetition transmissions are in progress.

For example, when UE is commanded or configured to switch to BWP #2 while DL channel repetition transmissions are in progress in BWP #1, the UE receives the DL channels that are transmitted in repetition based on conditions (or parameters) that are newly configured, by using the BWP #2 configuration. FIG. 4B shows a case in which, after BWP switching, the number of repetitions is changed to K=8 and repetition transmission is controlled. In this case, after the BWP switching, the UE receives the DL channel repetition transmissions corresponding to repetition numbers k=1 to 8, in BWP #2.

Also, when the UE is commanded or configured to switch to BWP #2 while UL channel repetition transmissions are in progress in BWP #1, the UE performs the UL channel repetition transmissions based on conditions (or parameters) that are newly configured, by using the BWP #2 configuration. FIG. 4B shows a case in which, after BWP switching, the number of repetitions is changed to K=8 and repetition transmission is controlled. In this case, after the BWP switching, the UE performs the UL channel repetition transmissions corresponding to repetition numbers k=1 to 8, in BWP #2.

Note that the conditions (or parameters) to apply to the repetition transmissions after the BWP switching may be included in the information to command BWP switching (for example, at least one of downlink control information and higher layer signaling) and reported from the base station to the UE.

Alternatively, part of the parameters to apply to repetition transmission (for example, the number of repetitions K, TBS, etc.) may be configured the same as before BWP switching, and other parameters (for example, subcarrier spacing, transmission power, etc.) may be determined based on the active BWP after the switching.

In this way, when BWP switching occurs during repetition transmission, the repetition transmission is carried out using new conditions that are configured after the change, so that appropriate conditions can be configured flexibly based on the BWP that is applied. By this means, the decline in the quality of communication can be reduced.

<HARQ-ACK Transmission Control>

When repetition transmission is carried out in UE operation 1 (see FIG. 4A) and UE operation 2 (see FIG. 4B), at least one of HARQ-ACK transmission controls 1 and 2, the HARQ-ACK transmission timing and the HARQ-ACK transmission resource, which have been described earlier with the second example, may be applied. For example, in at least one of FIGS. 4A and 4B, at least one of HARQ-ACK transmission controls 1 and 2, the HARQ-ACK transmission timing and the HARQ-ACK transmission resource, which have been described earlier with the second example, may be applied for the transmission control of HARQ-ACKs in response to PDSCHs that are subject to repetition transmission.

### Fourth Example

With a fourth example of the present invention, the BWP switching control for when UL transmission (for example, PUSCH) not scheduled by downlink control information or UL transmission that is based on semi-persistent scheduling (SPS) is subject to repetition transmission will be described.

UL transmission that is not scheduled by downlink control information (DCI) has a first type and a second type that use resources configured by higher layer signaling. The first type is also referred to as “configured grant type 1,” or “grant-free type 1.” The second type is also referred to as “configured grant type 2,” or “grant-free type 2.”

Configured grant type 2 is a method of activating/deactivating PUSCH resources pre-configured by higher layer using DCI. Configured grant type 1 is a method, which, on top of configured grant type 2, does not use DCI-induced activation/deactivation, and which carries out PUSCH transmission, when configured by RRC signaling, even if there is no L2/L1 command from a base station.

<Configured Grant Type 2/DL SPS>

UE assumes that, when PUSCH is transmitted in repetition based on configured grant type 2 or when DL SPS (PDSCH) is received in repetition, BWP switching does not take place during the repetition period. In this way, BWP switching is controlled so as not to take place during repetition transmission, so that UL transmission that is not scheduled by DCI can be performed using the same partial band (resource).

Furthermore, when the period P for performing repetition transmission of PUSCH is configured, the UE may control the repetition transmission based on the assumption that no BWP switching will take place during this period P. Note that the period P may be defined in advance by the specification, or may be reported from the base station to the UE using at least one of higher layer signaling and downlink control information. Furthermore, the period P may be configured to different values for every repetition transmission, or may be configured so as to apply in common to a number of repetition transmissions.

Also, even if repetition transmission is not configured during the period P, the UE may still assume that no BWP switching will take place during the period P. In this case, a configuration may be employed in which BWP switching is configured during the period between the period P configured for a predetermined repetition of transmission and the next period P. In this way, the period for making BWP switching is limited, so that repetition transmission using the same partial band can be configured properly.

Alternatively, a configuration may be employed in which the UE performs BWP switching when the UE detects a downlink control channel that is scrambled with an RNTI for a configured grant or SPS (also referred to as “CS-RNTI”), and, furthermore, this downlink control channel includes another BWP index that is different from the current BWP index. That is, just like when BWP switching is controlled based on the BWP index indicated by a downlink control channel that is not configured-grant-based or SPS-based, but that is scheduled on a dynamic basis, when a downlink control channel that is scrambled with a configured grant or RNTI (also referred to as CS-RNTI) for SPS is used, BWP switching is controlled based on the BWP index included in this downlink control channel. As a result of this, BWP switching can be properly controlled based on the BWP index included in DCI that commands activation of configured grants.

<Configured Grant Type 1>

When PUSCH repetition transmission is carried out using configured grant type 1, the UE assumes that BWP switching does not take place during the repetition period. In this way, BWP switching is controlled so as not to take place during repetition transmission, so that UL transmission that is not scheduled by DCI can be performed using the same partial band (resource).

Furthermore, when the period P for performing repetition transmission of PUSCH is configured, the UE may control the repetition transmission based on the assumption that no BWP switching will take place during this period P. Also, even if repetition transmission is not configured during the period P, the UE may still assume that no BWP switching will take place during the period P.

Alternatively, a configuration may be employed here in which the UE performs BWP switching even during the period for repetition transmission or during period P in which repetition transmission is configured. In this case, BWP switching may be commanded from the base station to the UE by using higher layer signaling, or may be controlled by a timer.

(Radio Communication System)

Now, the structure of a radio communication system according to one embodiment of this disclosure will be described below. In this radio communication system, communication is performed using one or a combination of the radio communication methods according to the herein-contained embodiments of this disclosure.

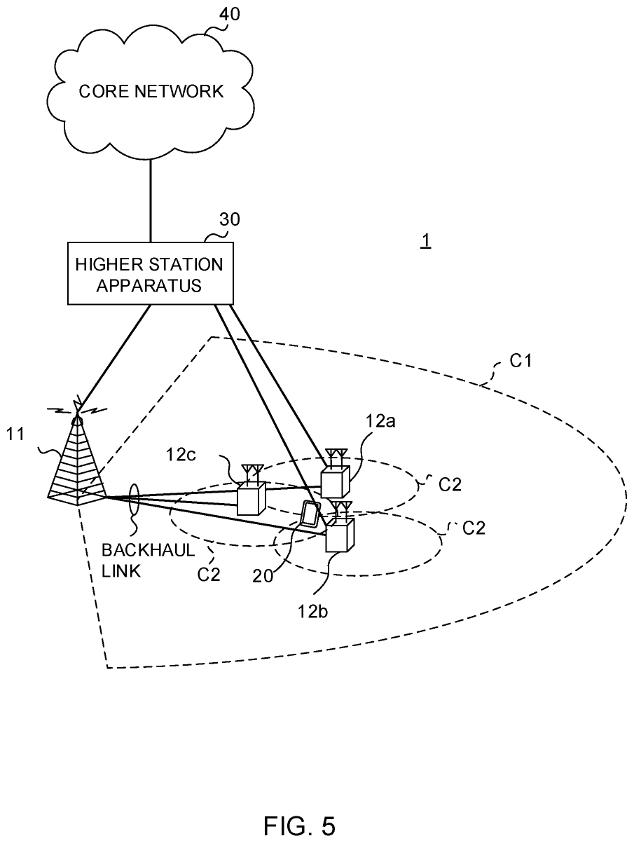

FIG. 5 is a diagram to show an exemplary schematic structure of a radio communication system according to the present embodiment. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes one unit.

Note that the radio communication system 1 may be referred to as “LTE (Long Term Evolution),” “LTE-A (LTE-Advanced),” “LTE-B (LTE-Beyond),” “SUPER 3G,” “IMT-Advanced,” “4G (4th generation mobile communication system),” “5G (5th generation mobile communication system),” “NR (New Radio),” “FRA (Future Radio Access),” “New-RAT (Radio Access Technology),” and so on, or may be seen as a system to implement these.

The radio communication system 1 includes a radio base station 11 that forms a macro cell C1, with a relatively wide coverage, and radio base stations 12 (12a to 12c) that are placed within the macro cell C1 and that form small cells C2, which are narrower than the macro cell C1. Also, user terminals 20 are placed in the macro cell C1 and in each small cell C2. The arrangement and number of cells and user terminals 20 and so forth are not limited to those illustrated in the drawings.

The user terminals 20 can connect with both the radio base station 11 and the radio base stations 12. The user terminals 20 may use the macro cell C1 and the small cells C2 at the same time by means of CA or DC. Furthermore, the user terminals 20 may execute CA or DC using a plurality of cells (CCs).

Between the user terminals 20 and the radio base station 11, communication can be carried out using a carrier of a relatively low frequency band (for example, 2 GHz) and a narrow bandwidth (referred to as, for example, an “existing carrier,” a “legacy carrier,” etc.). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the structure of the frequency band for use in each radio base station is by no means limited to these.

Furthermore, the user terminals 20 can communicate by using time division duplexing (TDD) and/or frequency division duplexing (FDD), in each cell. Furthermore, in each cell (carrier), a single numerology may be used, or a plurality of different numerologies may be used.

A numerology may refer to a communication parameter that is applied to the transmission and/or the receipt of a given signal and/or a channel, and represent at least one of the subcarrier spacing, the bandwidth, the length of symbols, the length of cyclic prefix, the length of subframes, the length of TTIs, the number of symbols per TTI, the radio frame configuration, the filtering process which the transmitter/receiver perform in the frequency domain, the windowing process which the transmitter/receiver perform in the time domain, and so on. For example, if there are physical channels between which the subcarrier spacing of the constituent OFDM symbols is different and/or the number of OFDM symbols is different, this may be interpreted as having different numerologies.

The radio base station 11 and a radio base station 12 (or two radio base stations 12) may be connected with each other by cables (for example, by optical fiber, which is in compliance with the CPRI (Common Public Radio Interface), the X2 interface and so on), or by radio.

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but these are by no means limiting. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. Also, the radio base stations 12 are radio base stations each having a local coverage, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter, the radio base stations 11 and 12 will be collectively referred to as “radio base stations 10,” unless specified otherwise.

The user terminals 20 are terminals that support various communication schemes such as LTE, LTE-A and so on, and may be either mobile communication terminals (mobile stations) or stationary communication terminals (fixed stations).

In the radio communication system 1, as radio access schemes, orthogonal frequency division multiple access (OFDMA) is applied to the downlink, and single-carrier frequency division multiple access (SC-FDMA) and/or OFDMA are applied to the uplink.

OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands that are each formed with one or contiguous resource blocks, per terminal, and allowing a plurality of terminals to use mutually different bands. Note that the uplink and downlink radio access schemes are not limited to the combinations of these, and other radio access schemes may be used as well.

In the radio communication system 1, a downlink shared channel (PDSCH (Physical Downlink Shared CHannel)), which is used by each user terminal 20 on a shared basis, a broadcast channel (PBCH (Physical Broadcast CHannel)), downlink L1/L2 control channels and so on are used as downlink channels. User data, higher layer control information, SIBs (System Information Blocks) and so on are communicated in the PDSCH. Also, the MIB (Master Information Blocks) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI), which includes PDSCH and/or PUSCH scheduling information and so on, is communicated by the PDCCH.

Note that scheduling information may be reported in DCI. For example, the DCI to schedule receipt of DL data may be referred to as “DL assignment,” and the DCI to schedule transmission of UL data may also be referred to as “UL grant.”

The number of OFDM symbols to use for the PDCCH is communicated by the PCFICH. HARQ (Hybrid Automatic Repeat reQuest) delivery acknowledgment information (also referred to as, for example, “retransmission control information,” “HARQ-ACKs,” “ACK/NACKs,” etc.) in response to the PUSCH is transmitted by the PHICH. The EPDCCH is frequency-division-multiplexed with the PDSCH (downlink shared data CHannel) and used to communicate DCI and so on, like the PDCCH.

In the radio communication system 1, an uplink shared channel (PUSCH (Physical Uplink Shared CHannel)), which is used by each user terminal 20 on a shared basis, an uplink control channel (PUCCH (Physical Uplink Control CHannel)), a random access channel (PRACH (Physical Random Access CHannel)) and so on are used as uplink channels. User data, higher layer control information and so on are communicated by the PUSCH. Also, in the PUCCH, downlink radio quality information (CQI (Channel Quality Indicator)), delivery acknowledgment information, scheduling requests (SRs) and so on are communicated. By means of the PRACH, random access preambles for establishing connections with cells are communicated.

In the radio communication system 1, cell-specific reference signals (CRSs), channel state information reference signals (CSI-RSs), demodulation reference signals (DMRSs), positioning reference signals (PRSs) and so on are communicated as downlink reference signals. Also, in the radio communication system 1, measurement reference signals (SRSs (Sounding Reference Signals)), demodulation reference signals (DMRSs) and so on are communicated as uplink reference signals. Note that the DMRSs may be referred to as “user terminal-specific reference signals (UE-specific reference signals).” Also, the reference signals to be communicated are by no means limited to these.

(Radio Base Station)

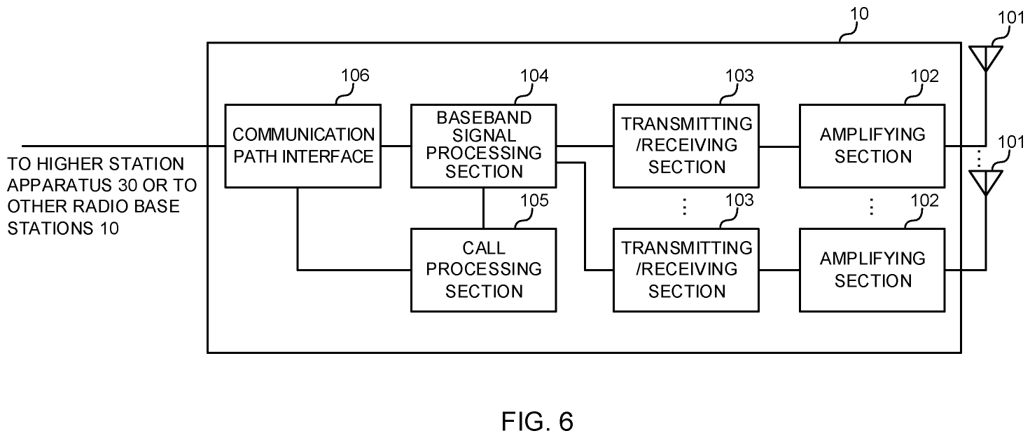

FIG. 6 is a diagram to show an exemplary overall structure of a radio base station according to the present embodiment. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30, to the baseband signal processing section 104, via the communication path interface 106.

In the baseband signal processing section 104, the user data is subjected to transmission processes, including a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present disclosure pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base station 10, and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (which is, for example, optical fiber that is in compliance with the CPRI (Common Public Radio Interface), the X2 interface, etc.).

The transmitting/receiving sections 103 carry out, in one or more partial frequency bands (BWPs (BandWidth Parts)) configured in a carrier, at least one of repetition transmission of downlink channels and receipt of uplink channels that are transmitted from the UEs in repetition. Furthermore, the transmitting/receiving sections 103 may transmit downlink control information for commanding activation of a predetermined BWP among the one or more BWPs configured in the carrier. Also, the transmitting/receiving sections 103 may transmit information about the repetition transmission of at least one of the DL channels and the UL channels, by using at least one of downlink control information, MAC control information and higher layer signaling (for example, applied parameters, and so on).

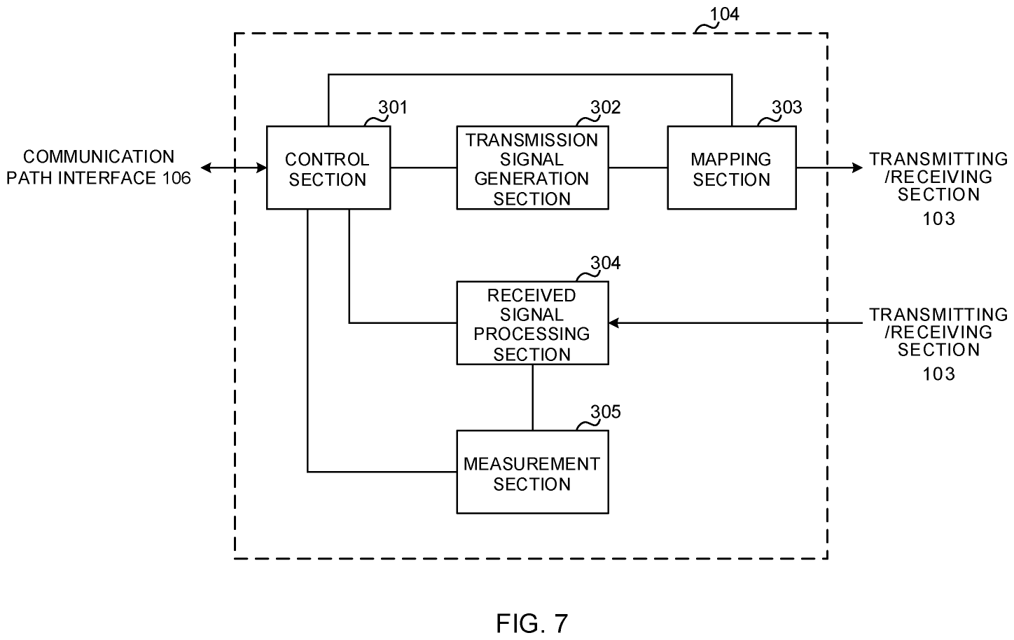

FIG. 7 is a diagram to show an exemplary functional structure of a radio base station according to the present embodiment. Note that, although this example primarily shows functional blocks that pertain to characteristic parts of the present embodiment, the radio base station 10 has other functional blocks that are necessary for radio communication as well.

The baseband signal processing section 104 at least has a control section (scheduler) 301, a transmission signal generation section 302, a mapping section 303, a received signal processing section 304 and a measurement section 305. Note that these configurations have only to be included in the radio base station 10, and some or all of these configurations may not be included in the baseband signal processing section 104.

The control section (scheduler) 301 controls the whole of the radio base station 10. The control section 301 can be constituted by a controller, a control circuit or control apparatus that can be described based on general understanding of the technical field to which the present disclosure pertains.

The control section 301 controls, for example, generation of signals in the transmission signal generation section 302, allocation of signals in the mapping section 303, and so on. Furthermore, the control section 301 controls signal receiving processes in the received signal processing section 304, measurements of signals in the measurement section 305, and so on.

The control section 301 controls the scheduling (for example, resource allocation) of system information, downlink data signals (for example, signals transmitted in the PDSCH) and downlink control signals (for example, signals transmitted in the PDCCH and/or the EPDCCH, such as delivery acknowledgment information). Also, the control section 301 controls the generation of downlink control signals, downlink data signals, and so on, based on the results of deciding whether or not retransmission control is necessary for uplink data signals, and so on.

The control section 301 controls the scheduling of synchronization signals (for example, PSS (Primary Synchronization Signal)/SSS (Secondary Synchronization Signal)), downlink reference signals (for example, CRS, CSI-RS, DMRS, etc.) and so on.

The control section 301 controls the scheduling of uplink data signals (for example, signals transmitted in the PUSCH), uplink control signals (for example, signals transmitted in the PUCCH and/or the PUSCH, such as delivery acknowledgment information), random access preambles (for example, signals transmitted in the PRACH), uplink reference signals, and so on.

The control section 301 controls the activation of one or more BWPs by using at least one of downlink control information, MAC control information and higher layer signaling. Furthermore, the control section 301 controls the repetition transmission of DL channels and UL channels. For example, the control section 301 exerts control so that no BWP switching takes place during at least one of repetition transmission of a downlink channel and repetition transmission of an uplink channel.

The transmission signal generation section 302 generates downlink signals (downlink control signals, downlink data signals, downlink reference signals, and so on) based on commands from the control section 301, and outputs these signals to the mapping section 303. The transmission signal generation section 302 can be constituted by a signal generator, a signal generating circuit or signal generating apparatus that can be described based on general understanding of the technical field to which the present disclosure pertains.

For example, the transmission signal generation section 302 generates DL assignments, which report downlink data allocation information, and/or UL grants, which report uplink data allocation information, based on commands from the control section 301. DL assignments and UL grants are both DCI, in compliance with DCI format. Also, the downlink data signals are subjected to the coding process, the modulation process and so on, by using coding rates and modulation schemes that are selected based on, for example, channel state information (CSI) from each user terminal 20.

The mapping section 303 maps the downlink signals generated in the transmission signal generation section 302 to predetermined radio resources based on commands from the control section 301, and outputs these to the transmitting/receiving sections 103. The mapping section 303 can be constituted by a mapper, a mapping circuit or mapping apparatus that can be described based on general understanding of the technical field to which the present disclosure pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminal 20 (uplink control signals, uplink data signals, uplink reference signals, etc.). The received signal processing section 304 can be constituted by a signal processor, a signal processing circuit or signal processing apparatus that can be described based on general understanding of the technical field to which the present disclosure pertains.

The received signal processing section 304 outputs the decoded information acquired through the receiving processes, to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signals. The measurement section 305 can be constituted by a measurer, a measurement circuit or measurement apparatus that can be described based on general understanding of the technical field to which the present disclosure pertains.

For example, the measurement section 305 may perform RRM (Radio Resource Management) measurements, CSI (Channel State Information) measurements, and so on, based on the received signals. The measurement section 305 may measure the received power (for example, RSRP (Reference Signal Received Power)), the received quality (for example, RSRQ (Reference Signal Received Quality), SINR (Signal to Interference plus Noise Ratio), SNR (Signal to Noise Ratio), etc.), the signal strength (for example, RSSI (Received Signal Strength Indicator)), transmission path information (for example, CSI) and so on. The measurement results may be output to the control section 301.

(User Terminal)

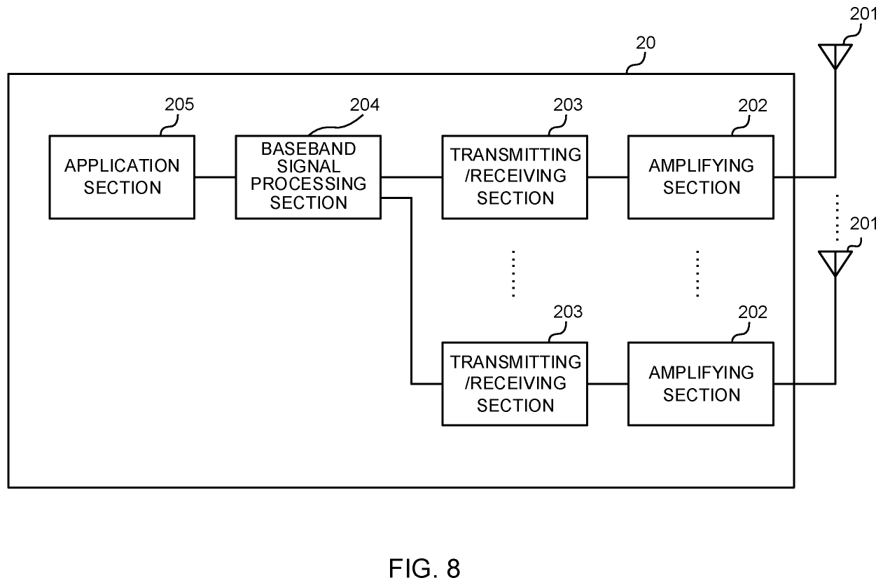

FIG. 8 is a diagram to show an exemplary overall structure of a user terminal according to the present embodiment. A user terminal 20 has a plurality of transmitting/receiving antennas 201, amplifying sections 202, transmitting/receiving sections 203, a baseband signal processing section 204, and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present disclosure pertains. Note that a transmitting/receiving section 203 may be structured as a transmitting/receiving section in one entity, or may be constituted by a transmitting section and a receiving section.

The baseband signal processing section 204 performs, for the baseband signal that is input, an FFT process, error correction decoding, a retransmission control receiving process, and so on. Downlink user data is forwarded to the application section 205. The application section 205 performs processes related to higher layers above the physical layer and the MAC layer, and so on. Also, in the downlink data, the broadcast information can be also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving sections 203.

Baseband signals that are output from the baseband signal processing section 204 are converted into a radio frequency band in the transmitting/receiving sections 203, and transmitted. The radio frequency signals that are subjected to frequency conversion in the transmitting/receiving sections 203 are amplified in the amplifying sections 202, and transmitted from the transmitting/receiving antennas 201.

In one or more BWPs configured in a carrier, the transmitting/receiving sections 203 carry out at least one of receipt of downlink channels that are transmitted in repetition, and repetition transmission of uplink channels. Furthermore, the transmitting/receiving sections 203 may receive downlink control information for commanding activation of a predetermined BWP among the one or more BWPs configured in the carrier. Also, the transmitting/receiving sections 203 may receive information about the repetition transmission of at least one of the DL channels and the UL channels, by using at least one of downlink control information, MAC control information and higher layer signaling (for example, applied parameters, and so on).

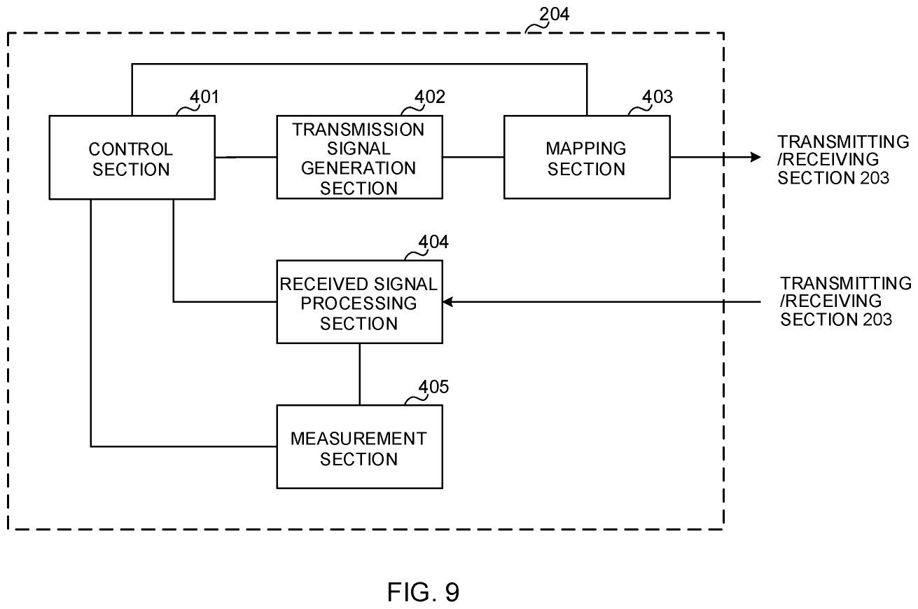

FIG. 9 is a diagram to show an exemplary functional structure of a user terminal according to the present embodiment. Note that, although this example primarily shows functional blocks that pertain to characteristic parts of the present embodiment, the user terminal 20 has other functional blocks that are necessary for radio communication as well.

The baseband signal processing section 204 provided in the user terminal 20 at least has a control section 401, a transmission signal generation section 402, a mapping section 403, a received signal processing section 404, and a measurement section 405. Note that these configurations have only to be included in the user terminal 20, and some or all of these configurations may not be included in the baseband signal processing section 204.

The control section 401 controls the whole of the user terminal 20. The control section 401 can be constituted by a controller, a control circuit or control apparatus that can be described based on general understanding of the technical field to which the present disclosure pertains.

The control section 401 controls, for example, generation of signals in the transmission signal generation section 402, allocation of signals in the mapping section 403, and so on. Furthermore, the control section 401 controls signal receiving processes in the received signal processing section 404, measurements of signals in the measurement section 405, and so on.

The control section 401 acquires the downlink control signals and downlink data signals transmitted from the radio base station 10, via the received signal processing section 404. The control section 401 controls the generation of uplink control signals and/or uplink data signals based on results of deciding whether or not retransmission control is necessary for the downlink control signals and/or downlink data signals, and so on.

The control section 401 controls the application of activation and repetition transmission of one or more BWPs based on at least one of downlink control information, MAC control information and higher layer signaling.

Also, when a switch from a first BWP to a second BWP is commanded or configured during repetition transmission, the control section 401 stops at least one of receipt of a downlink channel and transmission of an uplink channel, or controls receipt of a downlink channel and transmission of an uplink channel based on the configuration of the first BWP configuration or the configuration of the second BWP.

Also, the control section 401 may exert control so that, when BWP switching is commanded or configured while a downlink channel is transmitted in repetition, or part or all of the retransmission control signals (HARQ-ACKs) in response to each repeated transmission of the downlink channel are not transmitted. Alternatively, when the BWP is switched while the downlink channel is transmitted in repetition, the control section 401 may exert control, so that HARQ-ACKs in response to each repeated transmission of the downlink channel are transmitted after the BWP is switched.

Also, the control section 401 may exert control so that, when a switch from the first BWP to the second BWP is commanded or configured while repetition transmission is in progress, receipt of a downlink channel that is transmitted in repetition and repetition transmission of an uplink channel is continued using the same parameters or restarted by applying different parameters.

Also, the control section 401 may control repetition transmission based on the assumption that, when an uplink shared channel that is not scheduled by downlink control information is transmitted in repetition, no BWP switching takes place in at least one of the period for the repetition transmission and the period in which a predetermined repetition of transmission is configured.

The transmission signal generation section 402 generates uplink signals (uplink control signals, uplink data signals, uplink reference signals, etc.) based on commands from the control section 401, and outputs these signals to the mapping section 403. The transmission signal generation section 402 can be constituted by a signal generator, a signal generating circuit, or signal generation apparatus that can be described based on general understanding of the technical field to which the present disclosure pertains.

For example, the transmission signal generation section 402 generates uplink control signals such as delivery acknowledgement information, channel state information (CSI) and so on, based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and outputs these to the transmitting/receiving sections 203. The mapping section 403 can be constituted by a mapper, a mapping circuit or mapping apparatus that can be described based on general understanding of the technical field to which the present disclosure pertains.

The received signal processing section 404 performs receiving processes (for example, demapping, demodulation, decoding and so on) for received signals that are input from the transmitting/receiving sections 203. Here, the received signals include, for example, downlink signals (downlink control signals, downlink data signals, downlink reference signals, and so on) that are transmitted from the radio base station 10. The received signal processing section 404 can be constituted by a signal processor, a signal processing circuit or signal processing apparatus that can be described based on general understanding of the technical field to which the present disclosure pertains. Also, the received signal processing section 404 can constitute the receiving section according to the present disclosure.

The received signal processing section 404 outputs the decoded information acquired through the receiving processes, to the control section 401. The received signal processing section 404 outputs, for example, broadcast information, system information, RRC signaling, DCI and so on, to the control section 401. Also, the received signal processing section 404 outputs the received signals and/or the signals after the receiving processes to the measurement section 405.

The measurement section 405 conducts measurements with respect to the received signals. The measurement section 405 can be constituted by a measurer, a measurement circuit or measurement apparatus that can be described based on general understanding of the technical field to which the present disclosure pertains.

For example, the measurement section 405 may perform RRM measurements, CSI measurements, and so on, based on the received signals. The measurement section 405 may measure the received power (for example, RSRP), the received quality (for example, RSRQ, SINR, SNR, etc.), the signal strength (for example, RSSI), transmission path information (for example, CSI), and so on. The measurement results may be output to the control section 401.

(Hardware Structure)

Note that the block diagrams that have been used to describe the above embodiment show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically-separate pieces of apparatus (by using cables and/or radio, for example) and using these multiple pieces of apparatus.

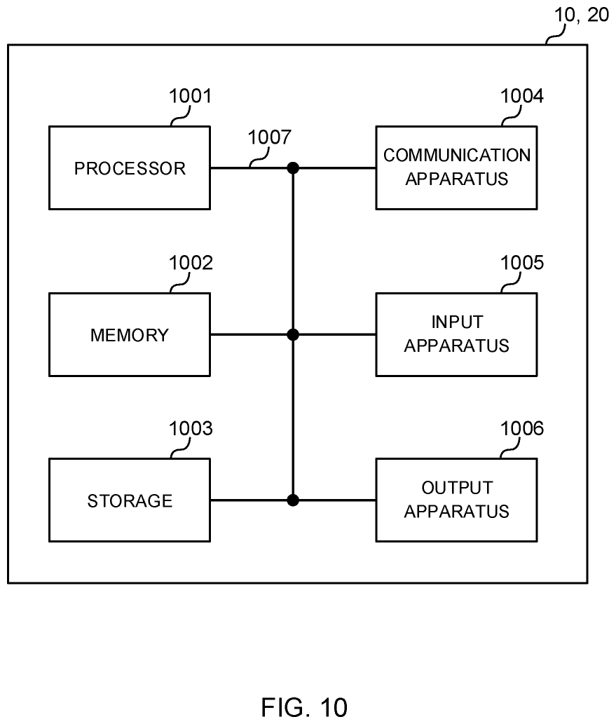

For example, the radio base station, user terminals and so on according to one embodiment of this disclosure of the present invention may function as a computer that executes the processes of the radio communication method of the present invention. FIG. 10 is a diagram to show an exemplary hardware structure of a radio base station and a user terminal according to the present embodiment. Physically, the above-described radio base stations 10 and user terminals 20 may be formed as a computer apparatus that includes a processor 1001, a memory 1002, a storage 1003, communication apparatus 1004, input apparatus 1005, output apparatus 1006, a bus 1007 and so on.

Note that, in the following description, the term “apparatus” may be replaced by “circuit,” “device,” “unit” and so on. The hardware structure of a radio base station 10 and a user terminal 20 may be designed to include one or more of each apparatus shown in the drawings, or may be designed not to include part of the apparatus.

For example, although only 1 processor 1001 is shown, a plurality of processors may be provided. Furthermore, processes may be implemented with one processor, or processes may be implemented simultaneously or in sequence, or by using different techniques, on one or more processors. Note that the processor 1001 may be implemented with one or more chips.

The functions of the radio base station 10 and the user terminal 20 are implemented by, for example, allowing hardware such as the processor 1001 and the memory 1002 to read predetermined software (programs), and allowing the processor 1001 to do calculations, control communication that involves the communication apparatus 1004, control the reading and/or writing of data in the memory 1002 and the storage 1003, and so on.

The processor 1001 controls the whole computer by, for example, running an operating system. The processor 1001 may be constituted by a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data, and so forth from the storage 1003 and/or the communication apparatus 1004, into the memory 1002, and executes various processes according to these. As for the programs, programs to allow computers to execute at least part of the operations of the above-described embodiment may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory), and other appropriate storage media. The memory 1002 may be referred to as a “register,” a “cache,” a “main memory (primary storage apparatus),” and so on. The memory 1002 can store executable programs (program codes), software modules and so on for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) or the like), a digital versatile disc, a Blu-ray (registered trademark) disk, etc.), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using cable and/or wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer and so on, in order to implement, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from outside (for example, a keyboard, a mouse, a microphone, a switch, a button, a sensor and so on). The output apparatus 1006 is an output device for allowing sending output to outside (for example, a display, a speaker, an LED (Light Emitting Diode) lamp, and so on). Note that the input apparatus 1005 and the output apparatus 1006 may be provided in an integrated structure (for example, a touch panel).

Furthermore, these pieces of apparatus, including the processor 1001, the memory 1002 and so on, are connected by the bus 1007, so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by these pieces of hardware. For example, the processor 1001 may be implemented with at least one of these pieces of hardware.

(Variations)

Note that, the terminology used in this specification and the terminology that is needed to understand this specification may be replaced by other terms that communicate the same or similar meanings. For example, a “channel” and/or a “symbol” may be replaced by a “signal” (or “signaling”). Also, a “signal” may be a “message.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency,” and so on.

Furthermore, a radio frame may be comprised of one or more periods (frames) in the time domain. One or more periods (frames) that constitute a radio frame may be each referred to as a “subframe.” Furthermore, a subframe may be comprised of one or more slots in the time domain. A subframe may be a fixed time duration (for example, 1 ms), which does not depend on numerology.

Furthermore, a slot may be comprised of one or more symbols in the time domain (OFDM (Orthogonal Frequency Division Multiplexing) symbols, SC-FDMA (Single Carrier Frequency Division Multiple Access) symbols, and so on). Also, a slot may be a time unit based on numerology. Also, a slot may include a plurality of minislots. Each minislot may be comprised of one or more symbols in the time domain. Also, a minislot may be referred to as a “subslot.”

A radio frame, a subframe, a slot, a minislot, and a symbol all refer to a unit of time in signal communication. A radio frame, a subframe, a slot, a minislot and a symbol may be each called by other applicable names. For example, one subframe may be referred to as a “transmission time interval (TTI),” or a plurality of consecutive subframes may be referred to as a “TTI,” or one slot or minislot may be referred to as a “TTI.” That is, a subframe and/or a TTI may be a subframe (1 ms) in existing LTE, may be a shorter period than 1 ms (for example, one to thirteen symbols), or may be a longer period of time than 1 ms. Note that the unit to represent a TTI may be referred to as a “slot,” a “minislot” and so on, instead of a “subframe.”

Here, a TTI refers to the minimum time unit for scheduling in radio communication, for example. For example, in LTE systems, a radio base station schedules the radio resources (such as the frequency bandwidth and transmission power each user terminal can use) to allocate to each user terminal in TTI units. Note that the definition of TTIs is not limited to this.

A TTI may be the transmission time unit of channel-encoded data packets (transport blocks), code blocks and/or codewords, or may be the unit of processing in scheduling, link adaptation, and so on. Note that, when a TTI is given, the period of time (for example, the number of symbols) in which transport blocks, code blocks and/or codewords are actually mapped may be shorter than the TTI.

Note that, when one slot or one minislot is referred to as a “TTI,” one or more TTIs (that is, one or more slots or one or more minislots) may be the minimum time unit of scheduling. Also, the number of slots (the number of minislots) to constitute this minimum time unit for scheduling may be controlled.

A TTI having a time length of 1 ms may be referred to as a “normal TTI” (TTI in LTE Rel. 8 to 12), a “long TTI,” a “normal subframe,” a “long subframe,” and so on. A TTI that is shorter than a normal TTI may be referred to as a “shortened TTI,” a “short TTI,” a “partial TTI” (or a “fractional TTI”), a “shortened subframe,” a “short subframe,” a “minislot,” a “sub-slot,” and so on.

Note that a long TTI (for example, a normal TTI, a subframe, etc.) may be replaced with a TTI having a time duration exceeding 1 ms, and a short TTI (for example, a shortened TTI) may be replaced with a TTI having a TTI length less than the TTI length of a long TTI and not less than 1 ms.

A resource block (RB) is the unit of resource allocation in the time domain and the frequency domain, and may include one or a plurality of consecutive subcarriers in the frequency domain. Also, an RB may include one or more symbols in the time domain, and may be one slot, one minislot, one subframe or one TTI in length. One TTI and one subframe each may be comprised of one or more resource blocks. Note that one or more RBs may be referred to as a “physical resource block (PRB (Physical RB)),” a “subcarrier group (SCG),” a “resource element group (REG),” a “PRB pair,” an “RB pair,” and so on.

Furthermore, a resource block may be comprised of one or more resource elements (REs). For example, one RE may be a radio resource field of one subcarrier and one symbol.

Note that the structures of radio frames, subframes, slots, minislots, symbols, and so on described above are simply examples. For example, configurations pertaining to the number of subframes included in a radio frame, the number of slots included in a subframe or a radio frame, the number of minislots included in a slot, the number of symbols and RBs included in a slot or a minislot, the number of subcarriers included in an RB, the number of symbols in a TTI, the length of symbols, the length of cyclic prefix (CP), and so on can be changed in a variety of ways.

Also, the information and parameters described in this specification may be represented in absolute values or in relative values with respect to predetermined values, or may be represented using other applicable information. For example, a radio resource may be specified by a predetermined index.

The names used for parameters and so on in this specification are in no respect limiting. For example, since various channels (PUCCH (Physical Uplink Control CHannel), PDCCH (Physical Downlink Control CHannel) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers, and/or from lower layers to higher layers. Information, signals, and so on may be input and/or output via a plurality of network nodes.

The information, signals, and so on that are input and/or output may be stored in a specific location (for example, in a memory), or may be managed in a control table. The information, signals, and so on to be input and/or output can be overwritten, updated, or appended. The information, signals, and so on that are output may be deleted. The information, signals, and so on that are input may be transmitted to other pieces of apparatus.

The method of reporting information is by no means limited to those used in the examples/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBs) and so on), MAC (Medium Access Control) signaling, etc.), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as “RRC messages,” and can be, for example, an “RRC connection setup message,” “RRC connection reconfiguration message,” and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent in an implicit way (for example, by not reporting this piece of information, by reporting another piece of information, and so on). Decisions may be made in values represented by 1 bit (0 or 1), may be made in Boolean values that represent true or false, or may be made by comparing numerical values (for example, comparison against a predetermined value).

Software, whether referred to as “software,” “firmware,” “middleware,” “microcode,” or “hardware description language,” or called by other names, should be interpreted broadly, to mean instructions, instruction sets, codes, code segments, program codes, programs, subprograms, software modules, applications, software applications, software packages, routines, subroutines, objects, executable files, execution threads, procedures, functions, and so on.

Also, software, instructions, information and so on may be transmitted and received via communication media. For example, when software is transmitted from a website, a server or other remote sources by using wired technologies (coaxial cables, optical fiber cables, twisted-pair cables, digital subscriber lines (DSL) and so on), and/or wireless technologies (infrared radiation, microwaves, and so on), these wired technologies and/or wireless technologies are also included in the definition of communication media.

The terms “system” and “network” as used herein are used interchangeably.

As used herein, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell,” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

As used herein, the terms “mobile station (MS),” “user terminal,” “user equipment (UE),” and “terminal” may be used interchangeably.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other suitable terms.

Furthermore, the radio base stations in this specification may be interpreted as user terminals. For example, each example/embodiment of this disclosure may be applied to a configuration in which communication between a radio base station and a user terminal is replaced with communication among a plurality of user terminals (D2D (Device-to-Device)). In this case, user terminals 20 may have the functions of the radio base stations 10 described above. In addition, terms such as “uplink” and “downlink” may be interpreted as “side.” For example, an “uplink channel” may be interpreted as a “side channel.”

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by their upper nodes. In a network comprised of one or more network nodes with base stations, it is clear that various operations that are performed so as to communicate with terminals can be performed by base stations, one or more network nodes (for example, MMEs (Mobility Management Entities), S-GWs (Serving-Gateways), and so on may be possible, but these are not limiting) other than base stations, or combinations of these.

The examples/embodiments illustrated in this specification may be used individually or in combinations, which may be switched depending on the mode of implementation. Also, the order of processes, sequences, flowcharts, and so on that have been used to describe the examples/embodiments herein may be re-ordered as long as inconsistencies do not arise. For example, although various methods have been illustrated in this specification with various components of steps in exemplary orders, the specific orders that are illustrated herein are by no means limiting.

The examples/embodiments illustrated in this specification may be applied to systems that use LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), other adequate radio communication methods, and/or next-generation systems that are enhanced based on these.

The phrase “based on” as used in this specification does not mean “based only on” unless otherwise specified. In other words, the phrase “based on” means both “based only on” and “based at least on.”

Reference to elements with designations such as “first,” “second,” and so on as used herein does not generally limit the number/quantity or order of these elements. These designations are used herein only for convenience, as a method for distinguishing between two or more elements. It follows that reference to the first and second elements does not imply that only two elements may be employed or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database, or some other data structure), ascertaining, and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing, and so on. In other words, to “judge” and “determine” as used herein may be interpreted to mean making judgements and determinations related to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be interpreted as “access.”

As used herein, when two elements are connected, these elements may be considered “connected” or “coupled” to each other by using one or more electrical wires, cables, and/or printed electrical connections, and, as a number of non-limiting and non-inclusive examples, by using electromagnetic energy having wavelengths of the radio frequency region, the microwave region and/or the optical region (both visible and invisible).

In the present specification, the phrase “A and B are different” may mean “A and B are different from each other.” The terms such as “leave,” “coupled” and the like may be interpreted as well.

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the invention according to the present disclosure has been described in detail above, it should be obvious to a person skilled in the art that the invention according to the present disclosure is by no means limited to the embodiments described herein. The present disclosure can be implemented with various corrections and in various modifications, without departing from the spirit and scope of the present invention defined based on the recitations of claims. Consequently, the description herein is provided only for the purpose of explaining examples, and should by no means be construed to limit the invention concerning this disclosure in any way.

1. A user terminal comprising:
at least one of a receiving section and a transmission section, the receiving section receiving a downlink channel that is transmitted in repetition, and the transmission section transmitting an uplink channel in repetition, in one or more partial frequency bands (BWPs (Bandwidth Parts)) configured in a carrier; and
a control section that exerts control so that, when a switch from a first BWP to a second BWP is commanded or configured during the repetition transmission, at least one of the receipt of the downlink channel and the transmission of the uplink channel is stopped or carried out based on a configuration of the first BWP or a configuration of the second BWP.

2. The user terminal according to claim 1, wherein the control section exerts control so that, when BWP switching is commanded or configured while the repetition transmission of the downlink channel is in progress, part or all of retransmission control signals (HARQ-ACKs) in response to each repeated transmission of the downlink channel are not transmitted.

3. The user terminal according to claim 1, wherein the control section exerts control so that, even when a BWP is switched during the repetition transmission of the downlink channel, retransmission control signals (HARQ-ACKs) in response to each repeated transmission of the downlink channel are transmitted after the BWP is switched.

4. The user terminal according to claim 1, wherein the control section exerts control so that, when the switch from the first BWP to the second BWP is commanded or configured during the repetition transmission, the receipt of the downlink channel that is transmitted in repetition and the repetition transmission of the uplink channel are continued based on a same parameter or restarted by applying a different parameter.

5. The user terminal according to claim 1, wherein the control section controls the repetition transmission based on an assumption that, when an uplink shared channel that is not scheduled by downlink control information is transmitted in repetition, no BWP switching takes place at least in one of a period for the repetition transmission and a period in which a predetermined repetition of transmission is configured.

6. A base station comprising:
at least one of a receiving section and a transmission section, the transmission section transmitting a downlink channel in repetition, and the receiving section receiving an uplink channel that is transmitted in repetition, in one or more partial frequency bands (BWPs (Bandwidth Parts)) configured in a carrier; and
a control section that exerts control so that no BWP switching takes place during at least one of the repetition transmission of the downlink channel and the repetition transmission of the uplink channel.

7. The user terminal according to claim 2, wherein the control section exerts control so that, when the switch from the first BWP to the second BWP is commanded or configured during the repetition transmission, the receipt of the downlink channel that is transmitted in repetition and the repetition transmission of the uplink channel are continued based on a same parameter or restarted by applying a different parameter.

8. The user terminal according to claim 3, wherein the control section exerts control so that, when the switch from the first BWP to the second BWP is commanded or configured during the repetition transmission, the receipt of the downlink channel that is transmitted in repetition and the repetition transmission of the uplink channel are continued based on a same parameter or restarted by applying a different parameter.

9. The user terminal according to claim 2, wherein the control section controls the repetition transmission based on an assumption that, when an uplink shared channel that is not scheduled by downlink control information is transmitted in repetition, no BWP switching takes place at least in one of a period for the repetition transmission and a period in which a predetermined repetition of transmission is configured.

10. The user terminal according to claim 3, wherein the control section controls the repetition transmission based on an assumption that, when an uplink shared channel that is not scheduled by downlink control information is transmitted in repetition, no BWP switching takes place at least in one of a period for the repetition transmission and a period in which a predetermined repetition of transmission is configured.

11. The user terminal according to claim 4, wherein the control section controls the repetition transmission based on an assumption that, when an uplink shared channel that is not scheduled by downlink control information is transmitted in repetition, no BWP switching takes place at least in one of a period for the repetition transmission and a period in which a predetermined repetition of transmission is configured.
